(19) United States
(12) Patent Application Publication
(10) Pub. No.: US 2026/0050500 A1
(43) Pub. Date: Feb. 19, 2026

(54) API PAYLOAD GENERATION USING GENERATIVE AI

(71) Applicant: SAP SE, Walldorf (DE)

(72) Inventors: Krishnan Harihara SUBRAMANIAN, Bangalore (IN); Dinesh BHANDARKAR, Bangalore (IN); Ajay P. SAKTHIKUMAR, Munnar (IN)

(21) Appl. No.: 18/802,221

(22) Filed: Aug. 13, 2024

(51) Int. Cl. G06F 9/54

(52) U.S. Cl. CPC G06F 9/547

(57) ABSTRACT

Systems and methods include reception of a query from a user, prompting of a text generation model to determine an object and an operation associated with the query from a plurality of object and operations, determination of an application programming interface (API) service associated with the object and metadata of the service, prompting of the text generation model to determine an entity of the service and a payload for the entity based on the query and the metadata, and presentation of the payload to the user.

### BACKGROUND

Today's organizations collect and store large sets of data at an ever-increasing rate. This data may be stored and managed by disparate data sources, including but not limited to databases, data warehouses, object stores, and data lakes. Accessing the data stored by such disparate data sources is required to effectively integrate the data into a coherent system.

A data source may implement an Application Programming Interface (API) to provide external applications with access to data stored within the data source. An API specification describes function calls provided by the API, including their fields, example field values, and example usages. Theoretically, an application or user may access data of a data source directly via these function calls, after determining which functions to use and how to use them in order to obtain the desired result.

Unfortunately, it can be difficult for a user or an application developer to correctly utilize an API exposed by a data source to obtain a desired result, or to test the API and identify failures prior to deployment. For example, API function calls typically require payloads, which may include entities such as document, model metadata, entity set, entity, entity reference(s), complex value(s), and primitive value(s). Even if the appropriate API endpoint and function call for a desired result could be determined, generation of a suitable payload for the function call can be problematic.

Systems are desired to facilitate payload generation for API calls.

### BRIEF DESCRIPTION OF THE DRAWINGS

FIG. 1 is a block diagram of an architecture to generate payloads and execute API calls according to some embodiments.

FIGS. 2A and 2B comprise a flow diagram of a process to generate payloads and execute API calls according to some embodiments.

FIG. 3 is a user interface for creating a query according to some embodiments.

FIG. 4 illustrates generation of a prompt based on a query and a prompt template according to some embodiments.

FIG. 5 is a tabular representation of API metadata according to some embodiments.

FIG. 6 is a user interface presenting an error based on a query according to some embodiments.

FIG. 7 is a user interface presenting a corrected query according to some embodiments.

FIG. 8 is a tabular representation of query validation information according to some embodiments.

FIG. 9 is a user interface presenting a query and a corresponding payload according to some embodiments.

FIG. 10 is a user interface presenting a query and a warning according to some embodiments.

FIG. 11 is a block diagram of a hardware environment to generate an API payload in response to a query according to some embodiments.

### DETAILED DESCRIPTION

The following description is provided to enable any person in the art to make and use the described embodiments and sets forth the best mode contemplated for carrying out some embodiments. Various modifications, however, will be readily-apparent to those in the art.

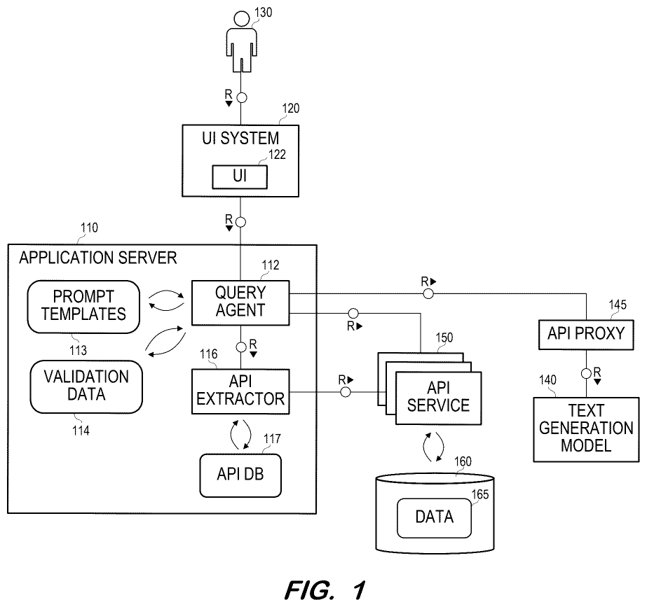

FIG. 1 is a block diagram of an architecture to generate payloads and execute API calls according to some embodiments. Each of the illustrated components may be implemented using any suitable combination of local, on-premise, cloud-based, distributed (e.g., including distributed storage and/or compute nodes) computing hardware and/or software that is or becomes known. Each component described herein may be executed by one or more physical and/or virtualized servers.

Two or more components of FIG. 1 may be co-located. In some embodiments, two or more components are implemented by a single computing device. One or more components may be implemented by a cloud service (e.g., Software-as-a-Service, Platform-as-a-Service). A cloud-based implementation of any components of FIG. 1 may apportion computing resources elastically according to demand, need, price, and/or any other metric.

Application server 110 may comprise one or more servers, virtual machines, clusters of a container orchestration system, etc. Application server 110 may provide an operating system, services, I/O, storage, libraries, frameworks, etc. to applications executing therein. Query agent 112 and API extractor 116 may comprise program code executable by application server 110 to operate as described herein.

For example, query agent 112 may receive queries (e.g., natural language queries) from UI system 120. UI system 120 may comprise a user device such as but not limited to a laptop computer, a desktop computer, a smartphone, and a tablet computer. UI system 120 includes one or more processing units to execute program code of UI 122.

UI 122 may comprise a Web browser or another application providing user interfaces for interacting with query agent 112. UI 122 may comprise a front-end UI application corresponding to query agent 112 which executes within a virtual machine of a Web browser to communicate with query agent 112 and present user interfaces thereof. User 130 may interact with such a user interface (e.g., using a keyboard and/or pointing device of system 120) to input a query for submission to query agent 112.

Query agent 112 constructs a prompt based on the query and one of prompt templates 113. The prompt is intended to prompt a text generation model to return an object and an operation associated with the query. Query agent 112 transmits the prompt to text generation model 140 via associated API proxy 145.

Text generation model 140 may comprise a neural network trained to generate text based on input text. Text generation model 140 may be implemented by, for example, executable program code, a set of hyperparameters defining a model structure and a set of corresponding weights, or any other representation of an input-to-output mapping which was learned as a result of the training. According to some embodiments, model 140 is an LLM conforming to a transformer architecture. A transformer architecture may include, for example, embedding layers, feedforward layers, recurrent layers, and attention layers. Generally, each layer includes nodes which receive input, change internal state according to that input, and produce output depending on the input and internal state. The output of certain nodes is connected to the input of other nodes to form a directed and weighted graph. The weights as well as the functions that compute the internal states are iteratively modified during training.

An embedding layer creates embeddings from input text, intended to capture the semantic and syntactic meaning of the input text. A feedforward layer is composed of multiple fully-connected layers that transform the embeddings. Some feedforward layers are designed to generate representations of the intent of the text input. A recurrent layer interprets the tokens (e.g., words) of the input text in sequence to capture the relationships between the tokens. Attention layers may employ self-attention mechanisms which are capable of considering different parts of input text and/or the entire context of the input text to generate output text.

Non-exhaustive examples of trained text generation model 140 include GPT-4, LaMDA, Claude or the like. Model 140 may be publicly available or deployed within a landscape which is trusted by a provider of application server 110. Similarly, text generation model 140 may be trained based on public and/or private data. According to some embodiments, model 140 is pre-trained with API-related information to improve the quality of its responses to query agent 112.

Text generation model 140 determines an object and an operation based on the prompt received from query agent 112. Query agent 112 transmits the object and operation within a request to API extractor 116. In response, API extractor 116 determines (e.g., by querying API database 117 and/or one of API services 150) an API service corresponding to the object and operation, as well as metadata associated with the API service. The metadata may include entities (i.e., functions) of the API service and fields of the entities.

API extractor 116 returns the determined information to query agent 112. Query agent 112 populates another one of prompt templates 113 with the information and the query and sends the resulting prompt to text generation model 140. The prompt prompts model 140 to generate a payload including one or more fields and one or more values per field.

Query agent 112 receives the generated payload and calls the determined entity of corresponding API service 150 with the operation and the payload. In some embodiments, query agent 112 also provides the payload to UI 122 for inspection by user 120.

API services 150 may comprise OData services of an Enterprise Resource Planning system but embodiments are not limited thereto. Data 165 may comprise tabular data stored in a columnar or row-based format, object data or any other type of data that is or becomes known. Data store 160 may comprise any suitable storage system such as database system, which may be partially or fully remote from application server 110 and may be distributed as is known in the art. Upon receiving a call, an API service 150 performs the task requested by the call on data 165 of data store 160 and returns a response to query agent 112.

If the call to the API service 150 returns an error, the error may also be presented to user 130. Any returned errors (e.g., missing field value) may also or alternatively be stored in validation data 114 as warnings in association with the object and operation of the call. Accordingly, upon determination of an object and operation based on an input query as described above, query agent 112 may determine whether validation data 114 includes any warnings associated with the object and operation. If so, query agent 112 may transmit the warnings to UI 122 for display to user 130. User 130 may then choose to revise the query based on the warnings.

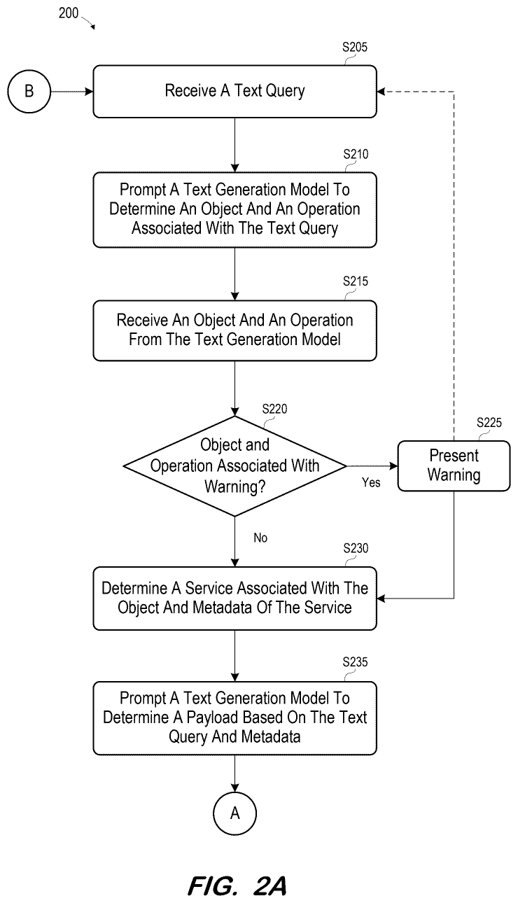

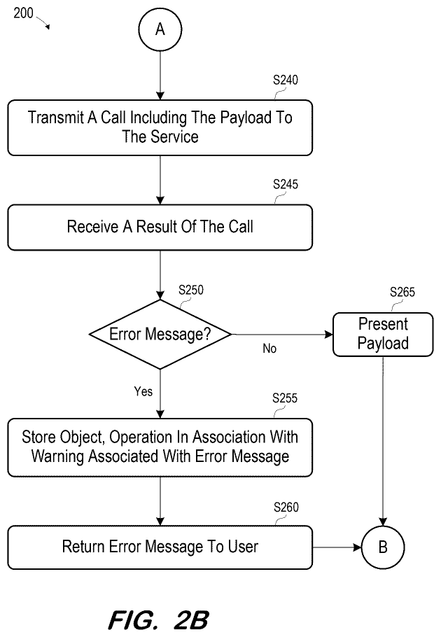

FIGS. 2A and 2B comprise a flow diagram of process 200 to generate payloads and execute API calls according to some embodiments. Process 200 and the other processes described herein may be performed using any suitable combination of hardware and software. Program code embodying these processes may be stored by any non-transitory tangible medium, including a fixed disk, a volatile or non-volatile random-access memory, a DVD, a Flash drive, or a magnetic tape, and executed by any one or more processing units, including but not limited to a processor, a processor core, and a processor thread. Embodiments are not limited to the examples described below.

A text query is received at S205. The query may be created in any suitable manner. A user may, for example, input the natural language query into an application UI and instruct the application to generate an API payload based on the query.

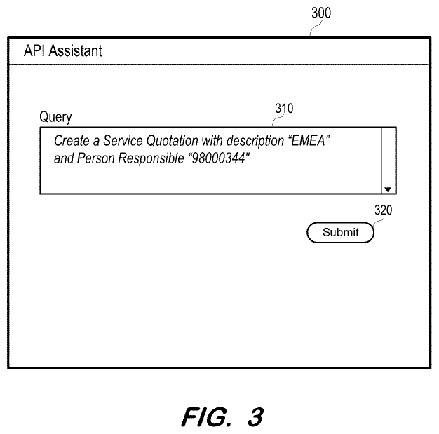

FIG. 3 illustrates user interface 300 of an application according to some embodiments. In one example, UI system 120 executes a Web browser to access query agent 112 via HTTP and to receive user interface 300 in return. User interface 300 includes field 310 for inputting the query. Submit control 320 is selectable to transmit the query to query agent 112 and to cause process 200 to proceed to S210.

A prompt is generated at S210. The prompt is intended to prompt a text generation model to determine an object and an operation associated with the received query. According to some embodiments of S210, query agent 112 identifies a suitable prompt template and populates the prompt template with the query. In some embodiments, the identified prompt template is provided to the model as a system prompt and the object and operation are provided within a user prompt. Appendix A illustrates a prompt template for use at S210 in some embodiments.

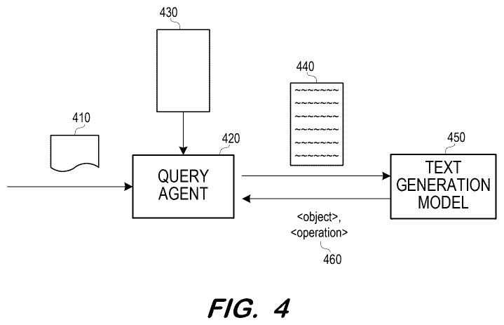

FIG. 4 illustrates S210 according to some embodiments. Query agent 420 receives query 410 and determines prompt template 430. Query agent 420 populates template 430 with query 410 to generate prompt 440. Query agent 420 transmits prompt 440 to text generation model 450 and, in response, model 450 determines an object and an operation 460 associated with the query. For example, model 450 may determine object: Service Quotation, operation: POST at S210 based on the query of FIG. 3. Query agent receives the determined object and operation at S215.

Next, at S220, query agent determines whether the received object and operation are associated with a warning. S220 may comprise any other validation processes that are or become known. In some examples, S220 comprises searching validation data 114 for any warnings associated with the object, operation pair. It will be assumed that no warnings are identified at S220 and flow therefore proceeds to S230.

A S230, a service corresponding to the object and metadata associated with the service are acquired. S230 may comprise searching an API service repository (e.g., api.sap.com) for an API service associated with the object. Once the service is located (e.g., API_SERVICE_QUOTATION_SRV), the metadata may be retrieved therefrom (e.g., using API_SERVICE_QUOTATION_SRV/$metadata). The metadata may include entities of the API service and fields of the entities.

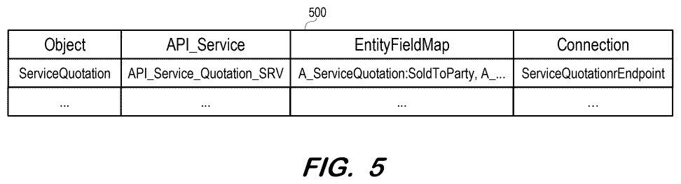

In some embodiments, the API services associated with various objects, and their respective metadata, are pre-loaded into a database table such as table 500 of FIG. 5. Embodiments are not limited to the structure of table 500. Each row of table 500 specifies an object and, for that object, an API service, a map of fields for each entity (e.g., {<entity₁: field₁>, <entity₁: field₂>, . . . <entityₘ: fieldₙ>}) of the API service and connection details for accessing the API service. In this regard, the connections to API services 150 and text generation model 140 should be preconfigured prior to process 200.

S230 may therefore comprise searching table 500 for a service and metadata corresponding to the given object. By pre-storing the API services and metadata, a user may pre-select a certain subset of the fields of the various entities for returning to query agent 112. The selected fields may be those fields which are expected to be queried by users. Selecting certain fields of the various entities reduces the amount of work required by the text generation model and may lead to more accurate results.

Based on the determined metadata and the text query, a text generation model is prompted to determine a payload at S235. Similarly to the description of S210 above, S235 may comprise determination of a suitable prompt template and population of the prompt template with the entities and fields of the API service. The populated prompt is transmitted to the text generation model and a response is received. Appendix B illustrates a prompt template for use at S235 in some embodiments.

Per the prompt, the response may be in JSON format and may specify an entity, the service, the operation, and a payload. The payload may comprise an array of field names, each associated with one or more values. In one example, the query received at S205 is “Create a Sales Quotation with customer 17100001 and item having product srv_01 with quantity 1” and the response received at S235 is “POST, A_ServiceQuotationItem” {“SoldToParty”: “17100001”, “to_Item”: [{“ServiceQuotation”: “600000123”, “Product”: “SRV_01”, “Quantity”: “1”}]}.

At S240, a call including the payload is transmitted to the API service. The call is a call to the entity (e.g., A_ServiceQuotationItem) and the payload includes fields of the entity and corresponding values. A result of the call is received at S245, and S250 determines whether an error message was received at S245. It will be assumed that an error message was received, for example indicating that the call is missing a value of a required field. Accordingly, at S255, a warning associated with the error message is stored in association with the current object and operation. The warning may be stored in validation data 117, for example.

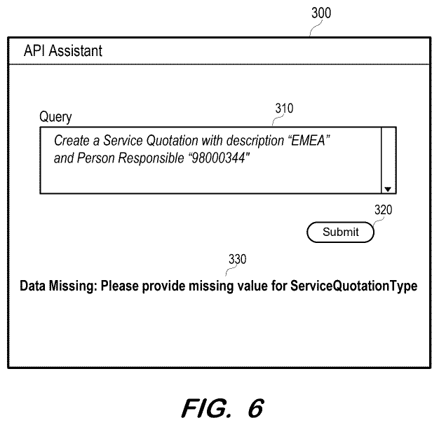

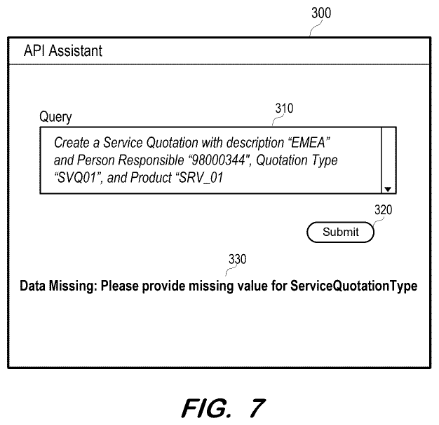

The error message is returned to the user at S260. FIG. 6 illustrates error message 330 according to some embodiments. Flow returns from S260 to S205, at which the user may revise and resubmit the query in view of the error message. FIG. 7 illustrates interface 300 after revision of the query of FIGS. 3 and 6 based on error message 330.

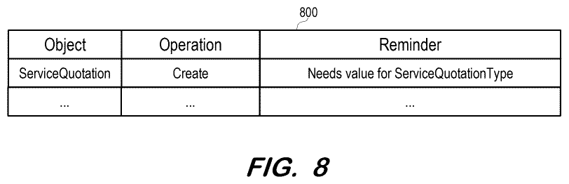

Upon selection of Submit control 320 of FIG. 7, flow proceeds through S210 and S215 as described above to determine object: ServiceQuotation, operation: POST based on the revised query. At S220, it is determined that the determined object and operation are associated with a warning. FIG. 8 illustrates table 800 of validation data according to some embodiments. Table 800 includes a row which was stored at S260 and which associates object: ServiceQuotation and operation: POST with a warning message.

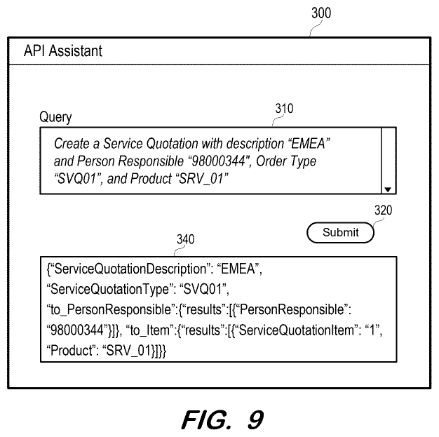

Flow proceeds to S225 to present the warning. In some embodiments, the user selects submit control 320 again to cause flow to proceed to S230 and continue through S245 as described above. It will be assumed that an error message is not received at S250, and the received payload is presented at S265. FIG. 9 illustrates user interface 300 including payload 340 according to some embodiments. Payload 340 may be re-used in any suitable manner, including but not limited to testing implementations of the API service, programming an application to communicate with the API service, etc.

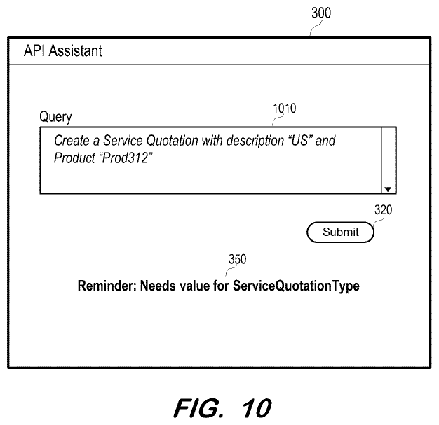

Flow then returns to S205 to await a next query. FIG. 10 illustrates new query 1010 received at S205. Flow may then proceed through S210 and S215 to determine object: ServiceQuotation, operation: POST based on query 1010. Next, it is determined at S220 that this object, operation pair are associated with a warning by table 800. Accordingly, warning 350 is presented at S225. The dashed line from S225 to S205 indicates that the user may wish to modify the query in response to the warning (i.e., return to S205) or continue with the current query (proceed to S230).

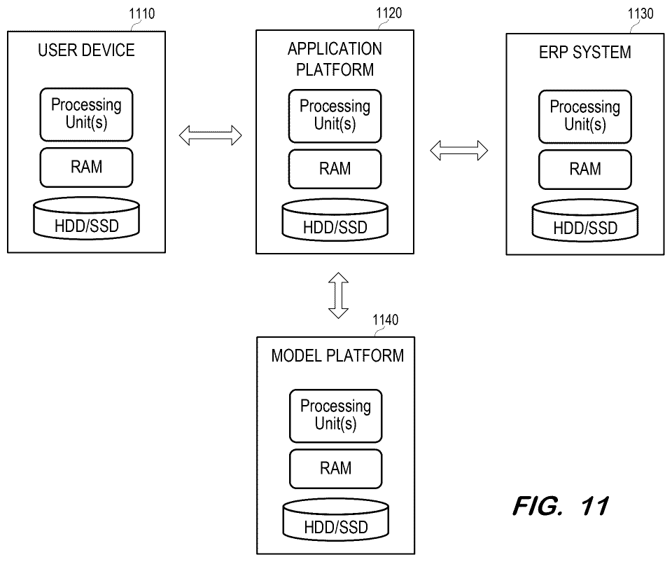

FIG. 11 is a block diagram of a cloud-based system according to some embodiments. Application platform 1120, ERP system 1130 and model platform 1140 may each comprise cloud-based resources, such as virtual machines, allocated by a cloud provider providing self-service and immediate provisioning, autoscaling, security, compliance and identity management features.

User device 1110 may interact with a user interface of an application executing on application platform 1120, for example via a Web browser executing on user device 1110, to input a query. Application platform 1120 may issue calls to model platform 1140 and ERP system 1130 as described herein to generate a payload based on the query.

The foregoing diagrams represent logical architectures for describing processes according to some embodiments, and actual implementations may include more, or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation some embodiments may include a processing unit to execute program code such that the computing device operates as described herein.

Embodiments described herein are solely for the purpose of illustration. Those in the art will recognize other embodiments may be practiced with modifications and alterations to that described above.

```
APPENDIX A
{
      “role″: ″user″,
    ″content″: ″You are a service assistant to identify an Object from a query. Return
only One object per query. List of candidate Objects is ServiceOrder,
ServiceConfirmation, ServiceTemplate, ServiceQuotation, ServiceContract,
SolutionOrder, SalesOrder, General, Null. If Object can't be determined, return Object =
Null.”
        },{
            ″role″: ″user″,
          ″content″: ″Create a Service Quotation or Create a Service Quotation with
Customer 17100001”
  },{
          ″role″: ″assistant″,
          ″content″: ″ServiceQuotation ″
        },{
          ″role″: ″user″,
          ″content″: ″If a command cannot be determined, but the query is relevant to
Service Quotation like Create a Service Quotation for the customer”
        },{
        ″role″: ″assistant″,
        ″content″: ″ ServiceQuotation ″
  }
```

```
APPENDIX B
  {
    “role”: “user”,
    “content”: “You are a payload generator for an entity of an API service.
You are to identify the fields of an API service entity and values of the fields
provided in the user input. Provide the output in json format opening with ′{′ and
closing with ′} and with double quotes for keys and values of the data. Keys must
be capitalized.
    The metadata for the API service is: < insert metadata>.
  },
  {
  “role”: “user”,
  “content”: “Create an item for the service quotation 60000123 with product
srv_01 and quantity 1”
  },
  {
  “role”: “assistant”,
  “content”: “POST, A_ServiceQuotationItem { “ServiceQuotation”: “60000123”,
“Product”: “srv_01”, “Quantity”: “1” }”
  },
  {
  “role”: “user”,
  “content”: “Update the quantity to 2 for service quotation 600000123 with item
10”
  },
  {
  “role”: “assistant”,
  “content”: “PATCH, A_ServiceQuotationItem { “ServiceQuotation”:
“600000123”, “ServiceQuotationItem”: “10”, “ServiceQuotationItemQty”: “2” }”
  }
  {
  “role”: “user”,
  “content”: “If the fields and values provided cannot be mapped then ask for whole
schema input”.
  },
  {
  “role”: “assistant”,
  “content”: “Whole schema required”
}
```

What is claimed is:

1. A system comprising:
a memory storing program code; and
one or more processing units to execute the program code to cause the system to:
receive a query from a user;
prompt a text generation model to determine an object and an operation associated with the query;
determine an application programming interface (API) service associated with the object and metadata of the service;
prompt the text generation model to determine an entity of the service and a payload for the entity based on the query and the metadata; and
present the payload to the user.

2. The system of claim 1, the one or more processing units to execute the program code to cause the system to:
transmit a call to the service, the call including the entity, the operation and the payload;
receive a result of the call from the service;
determine that the result includes an error message; and
return the error message to the user.

3. The system of claim 1, the one or more processing units to execute the program code to cause the system to:
transmit a call to the service, the call including the entity, the operation and the payload;
receive a result of the call from the service;
determine that the result includes an error message; and
store a warning associated with the error message in association with indicators of the object and the operation.

4. The system of claim 3, the one or more processing units to execute the program code to cause the system to:
receive a second query from a second user;
determine, using the text generation model, that the second query is associated with the object and the operation;
identify the stored warning based on the object and the operation; and
present the stored warning to the user.

5. The system of claim 1, the one or more processing units to execute the program code to cause the system to:
receive a second query from a second user;
prompt the text generation model to determine a second object and a second operation associated with the second query;
determine a second API service associated with the second object and second metadata of the second service;
prompt the text generation model to determine a second entity of the second service and a second payload for the second entity based on the second query and the second metadata; and
present the second payload to the second user.

6. The system of claim 5, wherein determination of the API service associated with the object and metadata of the service comprises:
searching a data store for the API service, a plurality of entities of the API service, and one or more fields of each of the plurality of entities, and
wherein determination of the second API service associated with the second object and second metadata of the second service comprises:
searching the data store for the second API service, a plurality of entities of the second API service, and one or more fields of each of the plurality of entities of the second API service.

7. The system of claim 1, wherein determination of the API service associated with the object and metadata of the service comprises:
searching a data store for the API service, a plurality of entities of the API service, and one or more fields of each of the plurality of entities.

8. A method comprising:
receiving a query from a user;
prompting a text generation model to determine an object and an operation associated with the query from a plurality of object and operations;
determining an application programming interface (API) service associated with the object and metadata of the service;
prompting the text generation model to determine an entity of the service and a payload for the entity based on the query and the metadata; and
presenting the payload to the user.

9. The method of claim 8, further comprising:
transmitting a call to the service, the call including the entity, the operation and the payload;
receiving a result of the call from the service;
determining that the result includes an error message; and
returning the error message to the user.

10. The method of claim 8, further comprising:
transmitting a call to the service, the call including the entity, the operation and the payload;
receiving a result of the call from the service;
determining that the result includes an error message; and
storing a warning associated with the error message in association with indicators of the object and the operation.

11. The method of claim 10, further comprising:
receiving a second query from a second user;
determining, using the text generation model, that the second query is associated with the object and the operation;
identifying the stored warning based on the object and the operation; and
presenting the stored warning to the user.

12. The method of claim 8, further comprising:
receiving a second query from a second user;
prompting the text generation model to determine a second object and a second operation associated with the second query;
determining a second API service associated with the second object and second metadata of the second service;
prompting the text generation model to determine a second entity of the second service and a second payload for the second entity based on the second query and the second metadata; and
presenting the second payload to the second user.

13. The method of claim 12, wherein determining the API service associated with the object and metadata of the service comprises:
searching a data store for the API service, a plurality of entities of the API service, and one or more fields of each of the plurality of entities, and
wherein determining the second API service associated with the second object and second metadata of the second service comprises:
searching the data store for the second API service, a plurality of entities of the second API service, and one or more fields of each of the plurality of entities of the second API service.

14. The method of claim 8, wherein determining the API service associated with the object and metadata of the service comprises:
searching a data store for the API service, a plurality of entities of the API service, and one or more fields of each of the plurality of entities.

15. One or more non-transitory computer-readable media storing program code that, when executed by a computing system, causes the computing system to perform operations comprising:
receiving a query from a user;
prompting a text generation model to determine an object and an operation associated with the query from a plurality of object and operations;
determining an application programming interface (API) service associated with the object and metadata of the service;
prompting the text generation model to determine an entity of the service and a payload for the entity based on the query and the metadata; and
presenting the payload to the user.

16. The one or more non-transitory computer-readable media of claim 15, where the program code, when executed by a computing system, causes the computing system to perform operations further comprising:
transmitting a call to the service, the call including the entity, the operation and the payload;
receiving a result of the call from the service;
determining that the result includes an error message; and
returning the error message to the user.

17. The one or more non-transitory computer-readable media of claim 15, where the program code, when executed by a computing system, causes the computing system to perform operations further comprising:
transmitting a call to the service, the call including the entity, the operation and the payload;
receiving a result of the call from the service;
determining that the result includes an error message; and
storing a warning associated with the error message in association with indicators of the object and the operation.

18. The one or more non-transitory computer-readable media of claim 17, where the program code, when executed by a computing system, causes the computing system to perform operations further comprising:
receiving a second query from a second user;
determining, using the text generation model, that the second query is associated with the object and the operation;
identifying the stored warning based on the object and the operation; and
presenting the stored warning to the user.

19. The one or more non-transitory computer-readable media of claim 15, where the program code, when executed by a computing system, causes the computing system to perform operations further comprising:
receiving a second query from a second user;
prompting the text generation model to determine a second object and a second operation associated with the second query;
determining a second API service associated with the second object and second metadata of the second service;
prompting the text generation model to determine a second entity of the second service and a second payload for the second entity based on the second query and the second metadata; and
presenting the second payload to the second user.

20. The one or more non-transitory computer-readable media of claim 15, wherein determining the API service associated with the object and metadata of the service comprises:
searching a data store for the API service, a plurality of entities of the API service, and one or more fields of each of the plurality of entities.
